(19) United States
(12) Patent Application Publication
(10) Pub. No.: US 2026/0117959 A1
(43) Pub. Date: Apr. 30, 2026

(54) MODULAR LIGHTING SYSTEM WITH CLIPS

(71) Applicant: Elite Lighting, Commerce, CA (US)

(72) Inventor: Hamid Rashidi Doust, Beverly Hills, CA (US)

(21) Appl. No.: 19/376,162

(22) Filed: Oct. 31, 2025

Related U.S. Application Data
(60) Provisional application No. 63/714,802, filed on Oct. 31, 2024.

(51) Int. Cl. F21V 21/04; F21S 8/02; F21V 14/06; F21V 19/00; F21V 29/70; F21Y 115/10

(52) U.S. Cl. CPC F21V 21/047; F21S 8/026; F21V 14/06; F21V 19/001; F21V 29/70; F21Y 2115/10

(57) ABSTRACT

Provided is a light fixture comprising; a body; a source of light placed inside the body; and a plurality of clips on outer side of the body, the clips having an arm and a mechanism from moving from a locked to an unlocked position; wherein the body is configured to be attached to a structure with the clips with a first pushing motion to lock the clips and a second pushing motion to unlock the clips, the pushing being defined from bottom to top.

### CROSS-REFERENCE

The present application claimed the benefit of application No. 63/714,802, filed on Oct. 31, 2024, which is incorporated by reference in its entirety.

### BACKGROUND SECTION OF THE INVENTION

Light fixtures are typically attached to a ceiling. There is a need in the art to secure a light fixture with the ceiling with minimal effort.

### SUMMARY SECTION OF THE INVENTION

Provided is a light fixture comprising; a body; a source of light placed inside the body; and a plurality of clips on outer side of the body, the clips having an arm and a mechanism from moving from a locked to an unlocked position; wherein the body is configured to be attached to a structure with the clips with a first pushing motion to lock the clips and a second pushing motion to unlock the clips, the pushing being defined from bottom to top. The body can be circular. The body can have a heat sink, and a portion below the heat sink, the portion below the heat sink having a cavity on bottom side. The light fixture can include LED (Light Emitting Diode) source of light, an LED holder below the LED source of light, and an optics below the LED holder, all placed inside of the cavity. The body can have a ledge where the circumference of the body increases from a top of the body to a bottom of the body. The light fixture can further include a plurality of openings on a top of the ledge for placement of the clips, wherein one clip is placed in each opening. A portion of the clip stays inside of the opening and a portion of the clip comes out of the opening. The opening is in form of a slot. The clip is attached to a spring on its bottom. The clip can be attached to a spring on its bottom. The light fixture is configured to be zoomed.

Provided is a light fixture comprising, a body with a heat sink on top, and a cavity below the heat sink, the body further having a ledge below the heat sink; a source of light placed inside the cavity; an optics placed below the source of light; a holder attached to the body to keep the optics in place; a plurality of openings on the ledge; a plurality of clips attached to the body; wherein the body is configured to be attached to a ceiling with the clips. The body is configured to attach to a mud ring. The clip has one or more outwardly arms, and a body (clip body) below the arms, the body (clip body) attached to a spring. The light fixture further comprises a lock attached to the spring to lock the spring. The ledge has openings for receiving the clip. The openings are in form of slots, with a portion of the clip inside the slot and a portion of the clip outside of the slot. The clip comprises or more outwardly arms, and a clip body below the arms. The clip moves at an angle in relation to the spring.

Provided is a light fixture comprising, a circular body with a heat sink on top, and a cavity below the heat sink, the body further having a ledge below the heat sink, the ledge formed by the body having a greater circumference on the body's bottom; a plurality of openings in the ledge; a source of light placed inside the cavity; and an optics placed below the source of light; a holder attached to the body to keep the optics in place; a plurality of openings on the ledge; a plurality of clips placed in the plurality of openings, with one clip placed in each opening; wherein the body is configured to be attached to a ceiling with the clips.

Provided is a modular light fixture comprising: a body having at bottom portion and a top portion, the top portion having a smaller circumference the bottom portion. The body can be in for of any shape, including circular, square, oval, or rectangular. When the body is circular, the diameter of the upper portion of the body is smaller than the diameter of the lower portion.

### DETAILED DESCRIPTION OF THE DRAWINGS

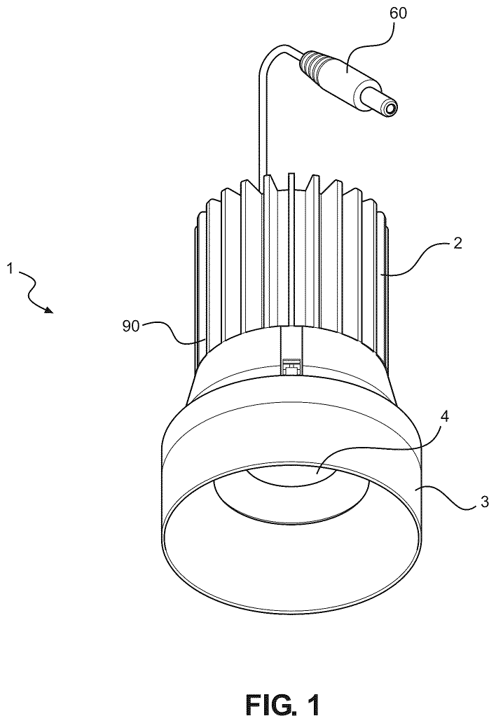

FIG. 1 illustrates a bottom perspective view of the light fixture with a clip.

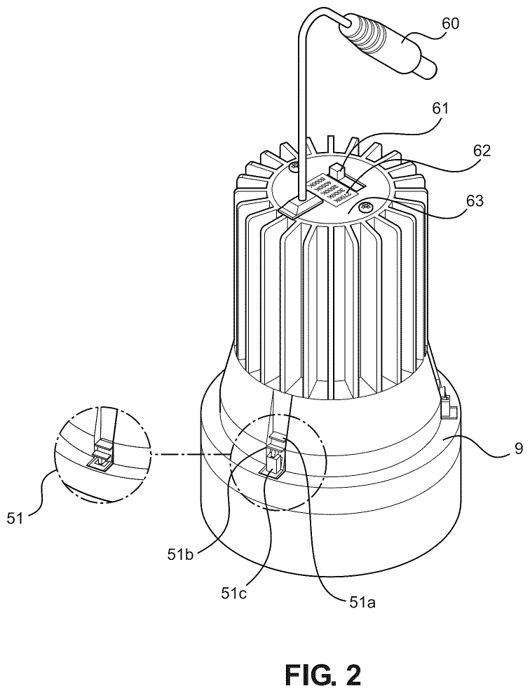

FIG. 2 illustrates a top perspective view of the light fixture with a clip.

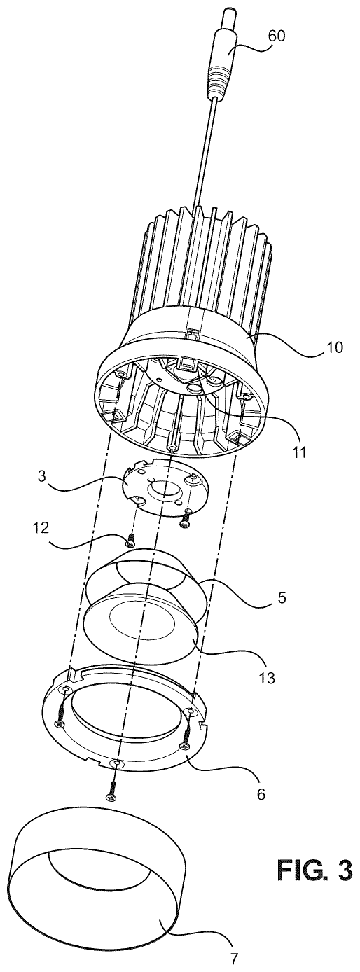

FIG. 3 illustrates a bottom exploded view of the light fixture.

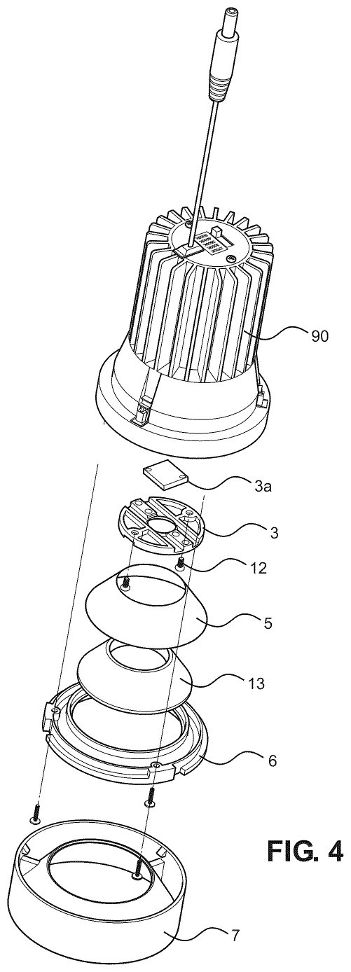

FIG. 4 illustrates a top exploded view of the light fixture.

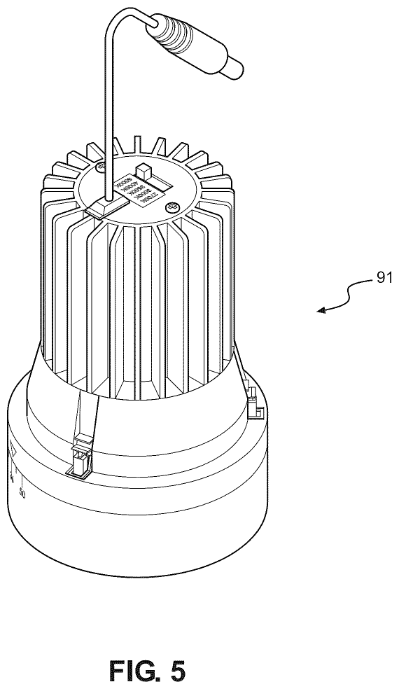

FIG. 5 illustrates a top perspective of the light fixture.

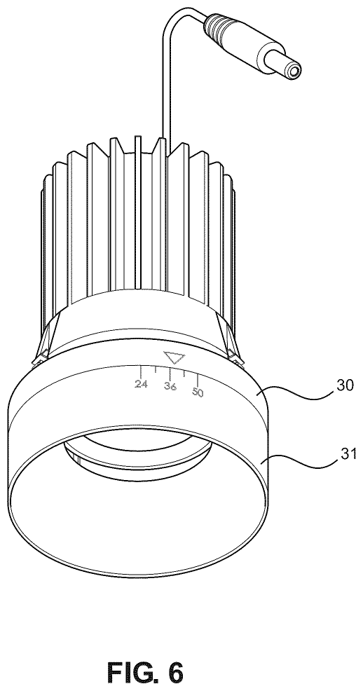

FIG. 6 illustrates a bottom perspective of the light fixture.

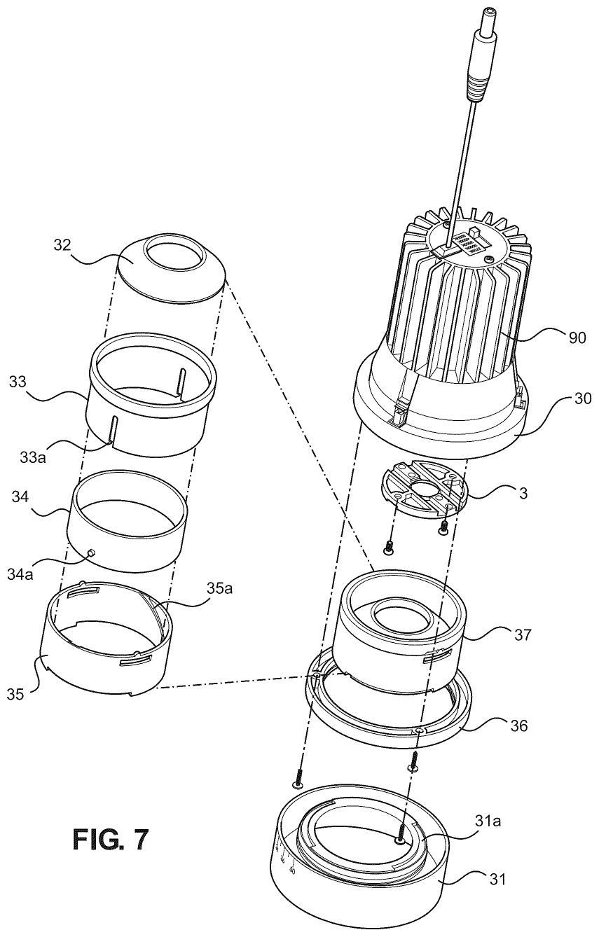

FIG. 7 illustrates a top exploded view of the light fixture.

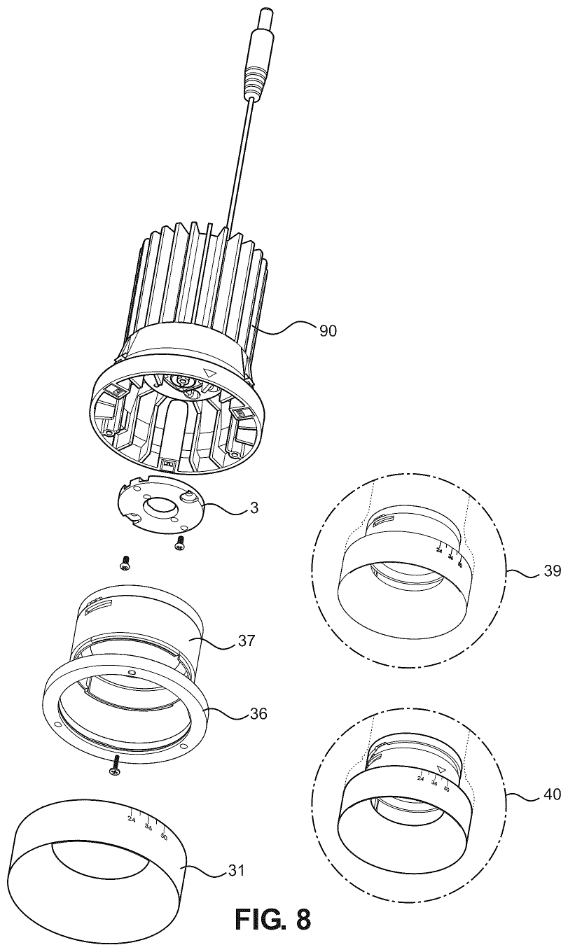

FIG. 8 illustrates a bottom exploded view of the light fixture.

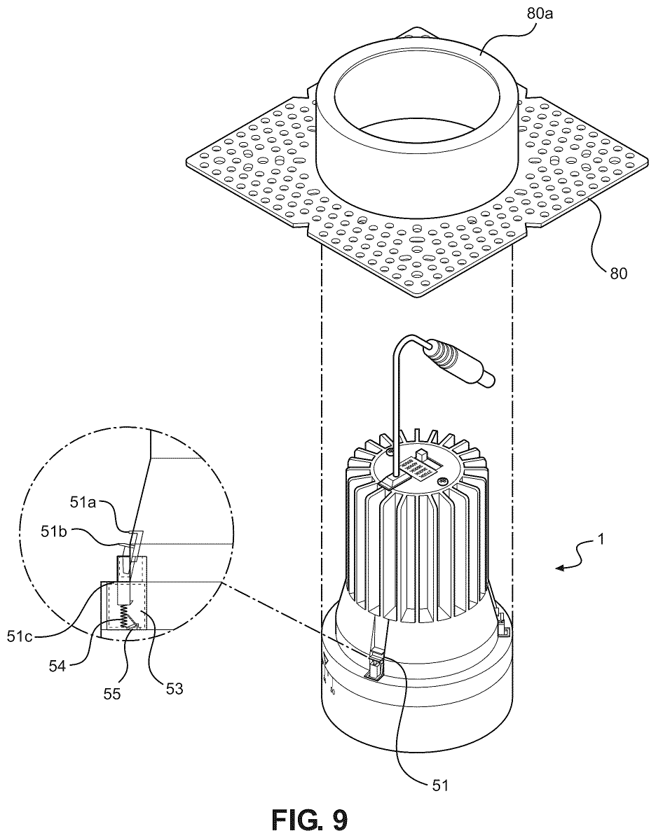

FIG. 9 illustrates the light fixture and the mud ring.

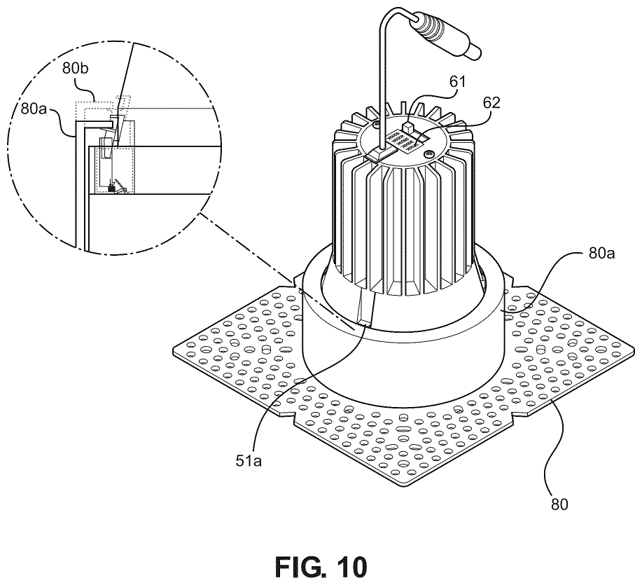

FIG. 10 illustrates the light fixture and the mud ring.

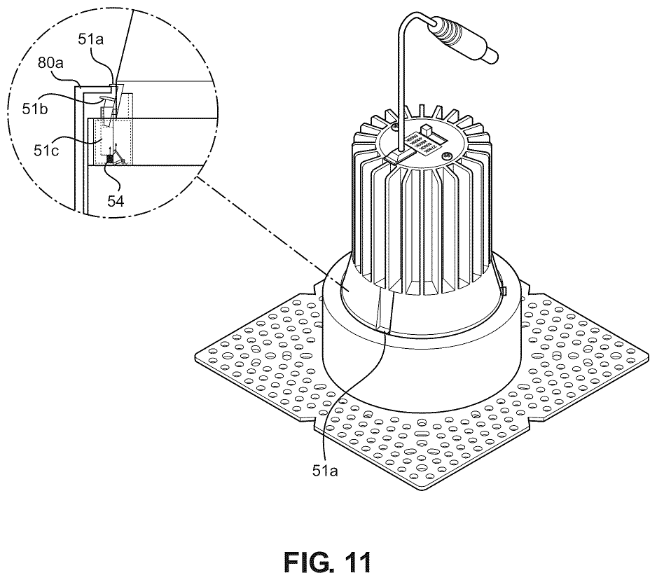

FIG. 11 illustrates the light fixture and the mud ring

### DETAILED DESCRIPTION OF THE INVENTION

FIG. 1 illustrates a bottom perspective view of the light fixture with a clip 51. FIG. 1 illustrates a body 90 with an aluminum heat sink 2 having fins. The body 90 has a flange/ledge with a greater circumference. As illustrated, the flange/ledge 9 has three openings, each for placement of a clip 51.

FIG. 2 illustrates a top perspective view of the light fixture with a clip 51. Illustrated in this view is heat sink 2 with a wire and plug 60 on top and a color changing power switch 61. The colors for the switch can be 2700 k to 5000 k, such as 2700 k, 3000 k, 3500 k, 4000 k, and 5000 k. An opening exists in the flange, which has a surface that is horizontal. Clip 51 is placed inside the opening, with a portion of the clip 51 inside the opening and another portion outside of the opening. The clip 51 can have two arms (51a, 51b) which come outwardly and are configured to attach to a structure outside of the light fixture (mud ring 80). As illustrated, the clip 51 has two substantially parallel arms (51a, 51b) facing outwardly, and having a gap of 0.1 to 0.6 cm in between them. The body 51c of clip 51 is placed below the two substantially parallel arms (51a, 51b).

FIGS. 3 and 4 illustrate an exploded view of the light fixture. The body of the light fixture 1 is circular and has a circular heat sink 2 with a plurality of fins. The bottom of the heat sink is placed in a circular bottom portion 10 of the body. The body bottom portion 10 has a cavity that fits over the heat sink 2 and has a cavity on bottom for receiving various components. An LED light source 11 is attached to inside of the cavity of the body, below the heat sink 2. A LED holder 3 is placed over the LED light source 11 and held in place with fasteners 11 that attach to bottom portion 10 of body. A conical reflector 5 with an opening in the middle is placed over the LED holder 3. An optic 13 is placed below the reflector 5. Ring 6 is placed over the optic 13 and attaches to the bottom of the cavity and trim 7 is placed below the ring 6. Ring 6 acts as a holder and keeps optic 13 in place.

A clip 51 is placed on outside of the body at the location where the circumference or diameter of the body 90 changes, specifically in the portion 10 of the body below heat sink 2. The clip 51 can have a claw which can be in form of arms (51a, 51b). The arms (51a, 51b) faces outwardly. The clip 51 is attached to the housing below heat sink 2.

The clip 51 can have a body portion 51c that has or is mechanically connected to a spring 54 mechanism. The base of the clip 51 can go inside of a substantially vertically oriented opening 53 that is placed on the bottom portion of the housing that comes out like a flange/ledge 9. The clip 51 can move in a circular motion. Pushing the light fixture can move the clip 51 and have it secure the light fixture in place. Pushing the light fixture a second time move the clip 51 and allows for removal of the light fixture.

FIG. 5 illustrates the assembled light fixture. Illustrated in this figure is the light fixture 91 with heat sink 2 and clip 51 placed inside an opening in the ledge. The color changing switch 61 and power wire are placed on top of the heat sink 2. The power wire can go to a junction box that has a power management unit.

FIGS. 7 and 8 illustrate exploded view of the light fixture configured to have optics with zoom capabilities. Body 90 has a cavity on the bottom. LED holder 3 is attached inside of the cavity below LED board-3a. Ring assembly 37 is made by placing ring 34 inside ring 33, and placing ring 35 outside of ring 33, and conical reflector 32 on the inside. Top of ring 33 has an outwardly flange that sits on top of ring 35. Ring 22 and 34 are mechanically connected to each other through notch 34a that fits and moves inside linear track 33a. Ring 33 and Ring 34 can move closer and further from each other depending on location of the notch 34a to linear track 33. Ring 35 has a bottom teeth portion, formed by missing portions that are complementary to the inner ring 31a of trim 31. As trim 31 is turned, assembly ring 37 is turned, and ring 34 moves up and down, changing the zoom of the optic 5. Ring/holder 36 secures the components inside of the body 30.

Rotation of trim 31 moves ring assembly 37, and results in changing the height of ring assembly 37, thereby increasing or decreasing the distance between the LED sources of light 3 and the optics 5 placed inside of the reflector 5. Notch 34a rides the track 35a, which is on inside of ring 34 and is a circular track that changes height. The zoom changes depending on location of notch 34a in track 35a. Zoomed 39 and un-zoomed 40 light fixture are illustrated, with the difference in location of the optics 4 depending on the zoom that is applied by a user.

FIG. 8 illustrates a light fixture configured to change the zoom of its optics by rotating trim 7. Movement of the trim 31 results in movement of the optics in relation to the LED light sources, creating a zoom effect for the light. As illustrated, an arrow is placed on bottom of body 90. Trim 31 is rotated to from 24 degrees to 50 degrees. The trim 31 can be rotated to adjust the zoom.

FIGS. 9, 10, and 11 illustrate attachment of the light fixture 1 (with zoom capability) to the ceiling, in this case with a mud ring 80. Mud ring 80 has a flat panel portion that attaches to the ceiling with fasteners. Mud ring 80 also has a ring portion 80a that can have a height of about 0.5 cm to 5 cm. The heat sink 2 is of a smaller diameter than the bottom of the light fixture 1 and passes through the ring 80a of the mud ring 80. The heat sink 2 passes through the mud ring 80a until arm 51a clicks/positions in placed above the mud ring 80a and stabilizes the light fixture 1. To release the light fixture, the light fixture is pushed upwardly, and arm 51b (and/or other components) pushes against the mud ring 80al, and releases spring 54 by unlocking lock 55. Clip 51 is placed in space 53 in the body of the light fixture. Space 53 and opening on top form a slot for placement of clip 51. A spring 54 is attached to the clip body 51c. The spring 54 is below the clip body 51c and is attached at both ends, top end to the clip body 51c and the bottom end to the bottom of space 53. Lock 55 locks the spring 54 when the spring 54 is compressed, and releases the spring 54 when the spring 54 is compressed again with a pushing mechanism. Lock 55 can be in form of a metal arm that is positioned against the spring 54 at an angle. Lock 55 can also have a base that is fixed, and which allows the arm of the lock 55 to pivot and move as the spring 54 is compressed.

FIG. 10 illustrates the spring 54 in a locked position and attached to mud ring 80 with arm 51. FIG. 11 illustrates with arrows the upward movement to unlock the spring 54.

The body 90 can be a unitary body or a plurality of parts of same or different materials joined together. In one embodiment, the body has an aluminum heat sink 2 with fins, which has a flange/ledge 9 on the bottom to increase its diameter and be configured to have space 53 in form of a slot with an open top. The body 90 can also be made from a unitary piece of aluminum with two different diameters.

When a user places the light fixture in the mud ring 80 (or other structure), clip 51 clicks in place, with the upper portion of the U (arm 51a) in clip 51 positioned above a frame or a trim or other structure attached to the ceiling. Optimally, the frame or a trim or other structure attached to the ceiling has a portion that fits in the U of clip 51 and/or allows arm 51a to be positioned above the structure to hold the light fixture.

The upper portion of the housing is configured to pass through an opening in a ceiling. The opening can be that of a frame attached to the ceiling, the frame having an opening. The top of the light fixture (such as heat sink 2) passes the opening of the frame or other similar structure (such as mud ring 80), and the bottom does not.

What is claimed is:

1. A light fixture comprising;
a. a body;
b. a source of light placed inside the body; and
c. a plurality of clips on outer side of the body, the clips having an arm and a mechanism from moving from a locked to an unlocked position;
wherein the body is configured to be attached to a structure with the clips with a first pushing motion to lock the clips and a second pushing motion to unlock the clips, the pushing being defined from bottom to top.

2. The light fixture of claim 1, wherein the body is circular.

3. The light fixture of claim 1, wherein the body has a heat sink, and a portion below the heat sink, the portion below the heat sink having a cavity on bottom side.

4. The light fixture of claim 3, further comprising an LED source of light, an LED holder below the LED source of light, and an optics below the LED holder, all placed inside of the cavity.

5. The light fixture of claim 1, wherein the body has a ledge where the circumference of the body increases from a top of the body to a bottom of the body.

6. The light fixture of claim 5, further comprising a plurality of openings on a top of the ledge for placement of the clips, wherein one clip is placed in each opening.

7. The light fixture of claim 6, wherein a portion of the clip stays inside of the openings and a portion of the clip comes out of the opening.

8. The light fixture of claim 6, wherein the opening is in form of a slot.

9. The light fixture of claim 1, wherein the clip is attached to a spring on its bottom.

10. The light fixture of claim 1, wherein the clip is attached to a spring on its bottom.

11. The light fixture of claim 1, wherein the light fixture is configured to be zoomed.

12. A light fixture comprising,
a. a body with a heat sink on top, and a cavity below the heat sink, the body further having a ledge below the heat sink;
b. a source of light placed inside the cavity; and
c. an optics placed below the source of light;
d. a holder attached to the body to keep the optics in place;
e. a plurality of openings on the ledge;
f. a plurality of clips attached to the body;
wherein the body is configured to be attached to a ceiling with the clips.

13. The light fixture of claim 11, wherein the body is configured to attach to a mud ring.

14. The light fixture of claim 11, wherein the clip has one or more outwardly arms, and a body (clip body) below the arms, the body (clip body) attached to a spring.

15. The light fixture of claim 12, further comprising a lock attached to the spring to lock the spring.

16. The light fixture of claim 11, wherein the ledge has openings for receiving the clip.

17. The light fixture of claim 15, wherein the openings are in form of slots, with a portion of the clip inside the slot and a portion of the clip outside of the slot.

18. The light fixture of claim 15, wherein the clip comprises or more outwardly arms, and a clip body below the arms.

19. The light fixture of claim 15, wherein the clip moves at an angle in relation to the spring.

20. A light fixture comprising,
a. a circular body with a heat sink on top, and a cavity below the heat sink, the body further having a ledge below the heat sink, the ledge formed by the body having a greater circumference on the body's bottom;
b. a plurality of openings in the ledge;
c. a source of light placed inside the cavity;
d. an optics placed below the source of light;
e. a holder attached to the body to keep the optics in place;
f. a plurality of openings on the ledge;
g. a plurality of clips placed in the plurality of openings, with one clip placed in each opening;
wherein the body is configured to be attached to a ceiling with the clips.
